(19) United States
(12) Patent Application Publication
(10) Pub. No.: US 2010/0010924 A1
(43) Pub. Date: Jan. 14, 2010

(54) ENERGY CREDIT HARVESTING

(75) Inventors: Lovell Brent Ivie, Sandy, UT (US); Douglas T. Stuart, Sandy, UT (US)

Correspondence Address: Workman Nydegger;1000 Eagle Gate Tower, 60 East South Temple, Salt Lake City, UT, 84111, US

(73) Assignee: Green Equity, LLC, South Jordan, UT (US)

(21) Appl. No.: 12/502,033

(22) Filed: Jul. 13, 2009

Related U.S. Application Data
(60) Provisional application No. 61/080,596, filed on Jul. 14, 2008.
(60) Provisional application No. 61/106,457, filed on Oct. 17, 2008.
(60) Provisional application No. 61/220,962, filed on Jun. 26, 2009.
(60) Provisional application No. 61/220,969, filed on Jun. 26, 2009.

(51) Int. Cl. G06Q 50/00; G06Q 30/00; G06Q 10/00; G06Q 90/00

(52) U.S. Cl. 705/34; 705/412; 705/500

(57) ABSTRACT

The harvesting of energy credits due to the transformation of a real estate property. The transformation results in improved energy usage of the real estate property, resulting in energy credits being earned by the owner of the real estate property. The energy credits are obtained by monitoring the power usage of the real estate property before the transformation, and after the transformation. An entity other than the owner of the real estate property facilitates the transformation by providing products or instructions that help make the transformation, or perhaps even by the entity taking at least partially responsibility for making the transformation. In consideration for the facilitation of the transformation, the entity receives at least a portion of the energy credits that result from the transformation.

### CROSS-REFERENCE TO RELATED APPLICATION

This patent application claims the benefit under 35 U.S.C. section 119(e) to U.S. provisional patent application Ser. No. 61/080,596, filed Jul. 14, 2008, and entitled “Method and Apparatus for Home Automation and Energy Conservation”, which provisional application is incorporated herein by reference in its entirely.

This patent application also claims the benefit under 35 U.S.C. section 119(e) to U.S. provisional patent application Ser. No. 61/106,457, filed Oct. 17, 2008, and entitled “Method and System for Generation, Authentication and Transfer of Conservation Credit”, which provisional application is incorporated herein by reference in its entirely.

This patent application also claims the benefit under 35 U.S.C. section 119(e) to U.S. provisional patent application Ser. No. 61/220,962, filed Jun. 26, 2009, and entitled “Reactance Compensation of Electrical System”, which provisional application is incorporated herein by reference in its entirely.

This patent application also claims the benefit under 35 U.S.C. section 119(e) to U.S. provisional patent application Ser. No. 61/220,969, filed Jun. 26, 2009, and entitled “Energy Credit Harvesting”, which provisional application is incorporated herein by reference in its entirely.

### BACKGROUND

Environmental protection has become more of a focus in recent times. The generation of energy has varying degrees of environmental impact, depending on how the energy is generated. To reduce the impact on the environment (also termed as reducing the “carbon footprint”), environmentally responsible individuals and corporations seek to reduce energy consumption and/or purchase renewable energy that is generated in a more environmentally friendly way. Some governments do or may impose mandates with the aim to reduce adverse impact on the environment due to individual or corporate actions. Thus, corporate and individual energy consumers are seeking ways to conserve energy through more efficient energy usage and/or through the use of renewable energy.

One way to reduce environmental impact is to actually generate renewable energy through, for example, wind power, solar power, hydro-electric power, geothermal power, and other sources of power that have lesser impact on the environment. However, an equivalent positive environmental impact may be achieved by purchasing renewable energy credits (RECs). Such RECs, also known as Green tags or Tradable Renewable Certificates (TRCs), are tradable environmental commodities in the United States. These credits represent proof that some amount of energy (currently 1 MegaWatt-Hour (MWh)) of electricity was generated from an eligible renewable energy resource. By purchasing such a credit, the owner of the credit can rightly claim that the owner's actions have resulted in that amount of renewable energy being generated. The credit is generated when the renewable energy is generated and verified, and issued originally to the entity that generated the renewable energy. That individual may then sell the credit on the open market in what is referred to as “environmental trading”.

Another way to conserve energy is to simply use less energy, or in other words, to improve energy efficiency. Energy credits are also earned when a certain amount of energy is conserved. Such energy credits are often referred to as Energy Efficiency Credits (EECs). EECs are documented using “White certificates” which certify that a certain reduction of energy consumption has been attained. Each white certificate represents 1 MWh of energy savings.

Thus, renewable energy credits are generated when a certain amount of renewable energy is generated and verified, and are earned by the entity that generated the renewable energy. Energy efficiency credits are generated when a certain amount of energy is conserved, and are earned by the entity that conserved the energy. Renewable energy credits and energy efficiency credits may then be bought and sold on the market. However, it is difficult for a smaller entity, such as an owner of a house, to take advantage of the renewable energy credits and energy efficiency credits that the homeowner has earned. For instance, it is difficult for a typical homeowner to document energy efficiency, and thereby verify to a proper certification authority that the energy credits have been earned. Thus, homeowners typically may improve energy efficiency of their real estate, but still an energy credit does not result. It is further difficult for a typical homeowner to sell the credit on the environmental trading markets.

### BRIEF SUMMARY

Embodiments described herein relate to the transformation of a real estate property, and to the harvesting of the resulting energy credits. The transformation results in improved energy usage of the real estate property, resulting in energy credits being earned by the owner of the real estate property. The energy credits are obtained by monitoring the power usage of the real estate property before the transformation, and after the transformation. An entity other than the owner of the real estate property facilitates the transformation by providing products or instructions that help make the transformation, or perhaps even by the entity taking at least partially responsibility for making the transformation. In consideration for the facilitation of the transformation, the entity receives at least a portion of the energy credits that result from the transformation.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a flowchart of a method for performing an exchange in which an entity facilitates transformation of a real estate property in addition to perhaps other consideration in exchange for at least a portion of the energy credits generated due to the transformation as well as perhaps other consideration;

FIG. 2 illustrates a flowchart of a method for using gathered monitored data resulting from the monitoring of power usage of a real estate property;

FIG. 3 illustrate a flowchart of a method for facilitating payment of a transfer fee through a real estate broker; and

FIG. 4 illustrates a computing system that may be used to implement portions of the method of FIGS. 1 through 3;

FIG. 5 abstractly illustrates a real estate property that has an electrical power system that has a net reactivity that is at least partially compensated for using a reactance module;

FIG. 6A illustrates a power vector diagram of an electrical power system that is experiencing a net positive reactance in the form of a net inductance;

FIG. 6B illustrates a power vector diagram of an electrical power system that is experiencing a net negative reactance in the form of a net capacitance;

FIG. 7 illustrates a circuit block diagram of a reactance module that represents one example of how the reactance module of FIG. 1 might be structured;

FIG. 8 illustrates a flowchart of a method for improving the electrical power efficiency of a real estate property;

FIG. 9 illustrates a distributed network that includes a reactance module installed in an electrical power system;

FIG. 10 illustrates a flowchart of a method for a reactance module to improve electrical power efficiency of an electrical system of a real estate property in conjunction with a remote control system.

### DETAILED DESCRIPTION

The present invention provides a method for transforming a real estate property to thereby improve energy usage of the real estate property. An entity that facilitates the transformation receives as at least partial consideration at least some of the energy credits that are obtained due to the improved energy usage of the real estate property. The energy credits may then be sold in environmental trading or otherwise used.

In practice, the owner of the improved real estate would hold title to any energy credit that might be generated as a result of the improvement to the real estate. Thus, that owner could transfer, via sale or for other consideration, the energy credit to another individual or entity. The energy credit is 1) “real” in the sense that the credit is a generated as a result of actual energy conservation, such as implementation of a technology upgrade that saves energy; 2) “verified” because each credit is generated as a result of metered or measured energy savings by a certified automated system; 3) “unique” because each energy credit is accompanied, identified and tracked from generation to consumption by a unique serial number; and 4) “valid” because each energy credit is tracked to ensure that it has achieved its environmental objective.

The generation of the energy credits according can then be certified in order to protect the purchaser of the credit through supply and sales audits, strict disclosure requirements and marketing reviews. Certification can be accomplished by an appropriate government agency (such as the Environmental Protection Agency in the case of the United States), or perhaps through an appropriate respected commercial agency.

These credits can then be securitized and monetized through an energy credit trading business. In one embodiment, the creation of the energy credit occurs via automated or electronic interfaces and are verified by an approved third party or state or regional authority, then stored by independent depositories. Marketers, brokers, utilities, energy companies, corporate buyers, governments, non-profit entities and individuals can trade the energy credits through the depository. A commodity future in such white tags could also be sold in advance at a discount since it is expected that energy credit values will rise with increasing governmental and social regulation. Such futures could be purchased by utility companies, governments, corporations, energy credit brokers and investors.

Thus, the consumer benefits from the transformation of the real estate by enjoying reduced energy costs, cash rebates, better quality of life, and peace of mind. Furthermore, the cost of the transformation is reduced because those facilitating the transformation receive energy credits resulting from the transformation in at least partial consideration for having facilitated the transformation. The consumer feels that they have received a bargain for the transformation because the consumer was unlikely to be able to obtain the energy credit in the first place.

Persons or entities buying energy credits know that they are helping to reduce energy consumption and thus are being environmentally responsible. Utility companies are in demand of partners that can help reduce energy consumption. The energy credits generated in the manner described herein make additional credits available for sale as demand increases. The energy credits also provide a viable investment for socially conscious money market funds, hedge funds, and so forth. Builders, developers and landlords are provided with a significant competitive advantage and potential eligibility for cash rebates, government subsidies, tax breaks and the like.

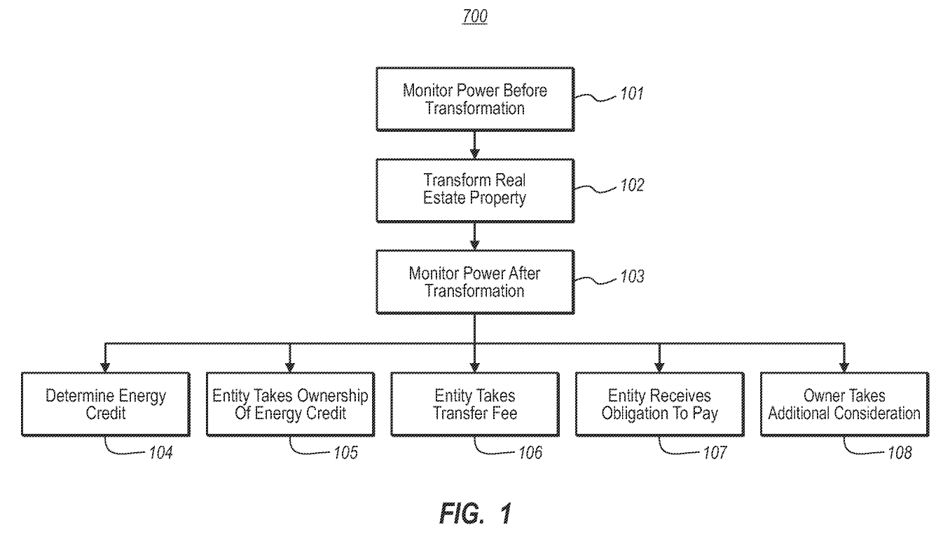

FIG. 1 illustrates a flowchart of a method 100 for generating an energy credit by transforming a real estate property, and severing the energy credit from the real estate property to facilitate payment for the transformation. The real estate property might be a residential dwelling such as an apartment, duplex, condo, single family dwelling or any other residential dwelling. The real estate property might also be a commercial estate such as, for example, a factory, an office complex, a hotel or motel, a store, or other real estate.

The transformation may be any change to the real estate property that causes an improved energy usage. For instance, the change might improve the amount of renewable energy created at the real estate property. For example, the transformation might include the installation of solar panels, installation of wind turbines, installation of geothermal heat generators, installation of hydro-electric generators, or the like.

Alternatively or in addition, the transformation might improve the energy efficiency of the property. For instance, the transformation might include the installation of highly insulating roofs, the installation of new windows, the installation of new air conditioning units, the installation of one or more furnaces, the installation of new electrical wiring, the installation of a home automation controller, the installation of efficient fireplaces, the installation of high efficiency lights, the installation of a power factor conditioner, the installation of programmable light switches, the installation of intelligent thermostats, or the like.

The method 100 monitors power usage of a real estate property before the transformation (act 101). In one embodiment, the transformation involves a home automation controller or other controller that controls power consumption in the real estate property. In that case, perhaps the controller disables all power-saving functionality and is just in monitoring mode. This would effectively measure the power usage before the transformation.

Note that the transformation of the real estate property need not be limited to transforming the land itself, or installing or repairing fixtures, but may also include providing equipment that is not tied to the land in the way that a fixture is. For instance, a wireless home automation controller might be portable, but yet its presence at or near the real estate property, or its ability to control power usage at the real estate property still may be interpreted to be a “transformation of real estate property” as the term is defined herein.

After monitoring the power usage of the real estate property for the transformation, a non-owner entity then facilitates the transformation of the property (act 102). This transformation may be “facilitated” by the entity actually making the physical transformation of the real estate property, providing product(s) that may be used to transform the real estate property, provide instructions for transforming the real estate property, provide a license to perform the acts required to transform the real estate property, and a combination thereof.

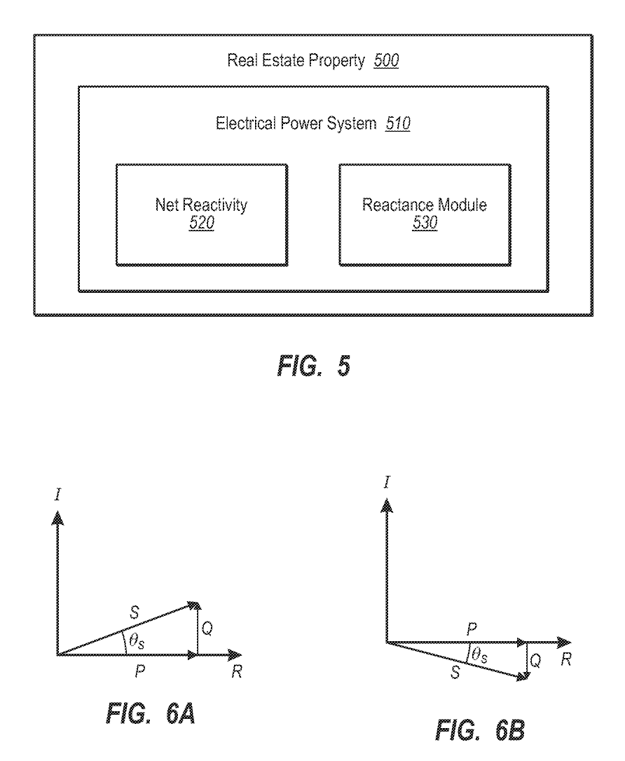

After the transformation is made, the power usage is again monitored (act 103). For instance, a power monitoring device may be installed into the electrical power system of the real estate property. Such a power monitoring device might be incorporated into a home automation system, although not required. The power monitoring system may monitor the power usage over a representative period of time. In order to ensure that the power usage is not manipulated, the power monitoring device may be configured to monitor power usage over an extended period of time, or perhaps at particular times that are unknown to the occupants of the real estate property. The power monitoring system may also report the power usage or other electrical efficiency characteristics over a network to a remote location based on one or more samplings of the power usage of the real estate property. An example of a power monitoring system that is capable of performing remote reporting and that can also perform power factor correction is described with respect to FIGS. 5 through 10 after the heading “REACTANCE COMPENSATION”.

The method then determines an energy credit that results from the transformation based on the monitoring (act 104). In the case of the remote reporting of power usage statistics, this remote reporting may be accomplished at a remote location from where the real estate property is. This remote location may include a computing system that permits for remote calculation of the earned energy credit associated with the transformation of the real estate property.

Alternatively, the energy credit may be created and even verified at the real estate property itself, as described in two United States provisional patent applications. The first-filed of such provisional applications is U.S. provisional patent application Ser. No. 61/080,596 filed Jul. 14, 2008, which is incorporated by reference herein in its entirety. The second-filed of such provisional applications is U.S. provisional patent application Ser. No. 61/106,457 filed Oct. 17, 2008, and entitled “Method and Apparatus for Generation, Authentication and Transfer of Energy Conservation Credits. Both of these applications are incorporated herein by reference in their entirety, and are used as a basis for a priority claim.

These provisional patent applications describe a home automation system that calculates the energy credit earned by improved energy efficiency. Once the home automation system calculates the credit, a data packet containing the calculated credit information is created. The data packet contains information that identifies the source of each credit as well as a unique identifier generated by the system that accompanies each credit to ensure that each credit is unique. The source information is generated by the system and includes the identity of the system controller that generated the credit, which will allow the central monitoring station to verify the authenticity of the credit. Each credit from a particular system will also be serialized so as to ensure that each credit from a particular system is a newly created credit. Once a data packet is created, the data packet is transmitted to the central monitoring station (i.e., a monitoring and processing service) that is in communication with each controller of every registered system. The data packets may be uniquely encrypted by the controller to ensure that such data packets are authentic. As data packets are received by the central monitoring station, each packet is verified to ensure that each conservation credit is authentic, valid and unique. If any information received in the data packet indicates that the credit has been previously received by the central monitoring station or that the data packet is not authentic, the credits contained in that particular data packet will be rejected. Once a credit has been authenticated, a unique serial number is assigned and a certificate (digital or otherwise) for that credit bearing the serial number is generated. The ownership of the credit can then be transferred, as by a sale of the credit to another entity.

Once the energy credit is generated, the owner provides consideration for the entity facilitating transformation of the real estate property by providing at least a portion of the earned energy credit (act 105). Accordingly, ownership rights in energy credits generated and/or recorded by the home automation system may be legally transferred from the owner of the real estate property to the entity that facilitated transformation as partial compensation for the transformation of the real estate property.

As potentially additional consideration, the owner may provide transfer fee rights in the real estate property (act 106). This may be accomplished through a restrictive covenant on the property in order to derive additional revenue that is associated with the property. The restrictive covenant would attach a transfer fee to the property such that any sale or other legal transfer of the property after the transformation would require a further transfer of monetary compensation to the entity that facilitated the transformation of the real estate property. Such a transfer fee might be a fixed fee and/or may be a percentage of the sale price of the real estate property (e.g., one percent). The transfer fee might apply to all subsequent sales of the real estate property, or may exclude some future sales. For instance, the initial sale of the property after the transformation is made might be excluded, or perhaps the restrictive covenant expires at some point after the transformation is made (e.g., 50 years or 100 years). Alternatively, the restrictive covenant may run in perpetuity. The restrictive covenant runs with the land and would thus be a recordable instrument to be recorded with the relevant government office to preserve the rights set forth in the covenant.

Another option for consideration as an alternative or in addition to the consideration mentioned above is that the owner enters into an obligation secured by the real estate property to pay the entity (act 107). Such payment may be a one time payment, or perhaps a recurring payment. The payment may also be associated with some further services offered by the entity that facilitated the transformation. For instance, the payment may be all or in part for a monitoring service that monitors the power usage of the real estate property for purposes of creating additional energy credits or further validating previously created energy credits.

As additional consideration provided by the entity that facilitated the transformation to the owner, the entity may provide additional consideration (act 108) such as services (such as monitoring services), coupons, money, or donations to charity.

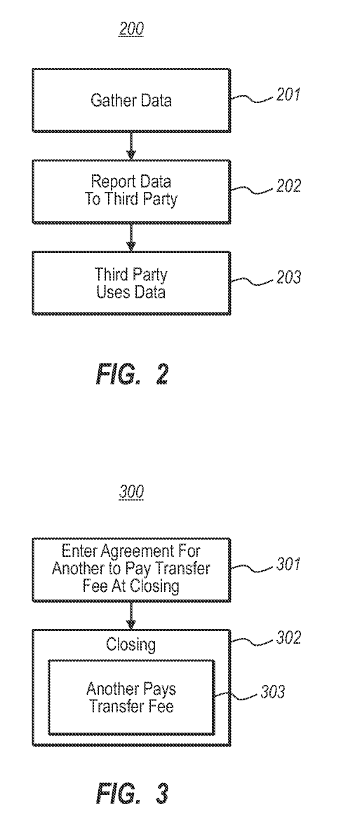

FIG. 2 illustrates a flowchart of a method 200 for gathering and using monitored data. The monitored data may be gathered, for example, during the monitoring acts (acts 101 and 103) performed before and after the transformation. Additionally, such monitored data may be provided as a service provided by the entity that facilitated the transformation of the real estate property.

According to the method, data is gathered regarding the monitored power usage (act 201). The gathered data, or a portion thereof, may be reported to a third party (act 202), preferably with the consent of the owner of the real estate property and certainly within the limits provided by the governing law. The third party may then use all or a portion of the gathered data for additional purposes (act 203). As an example, the third party may use the gathered data to identify offers that might be interesting to the owner. For instance, suppose that the monitored usage data is capable of detecting when power consumption devices (such as a refrigerator) turn on and off Over time, the monitored data may be used to detect that the power consumption device is becoming less efficient. The third party may thus present tailored offers that are accompanied with informative information regarding the power efficiency of the power consumption device. This might give the owner information regarding the efficacy of replacing or performing repairs on the power consumption device.

As previously mentioned, part of the compensation for the transformation might be a transfer fee imposed by restrictive covenant. FIG. 3 illustrates a flowchart of a method 300 for selling the real estate property when a transfer fee is attached therewith by restrictive covenant. The owner negotiates with a real estate broker involved or to be involved in the subsequent sale for the real estate broker to pay all or a portion of the transfer fee at the subsequent sale (act 301). During closing (act 302), the negotiated portion of the transfer fee is paid by the real estate broker (act 303), rather than by the seller.

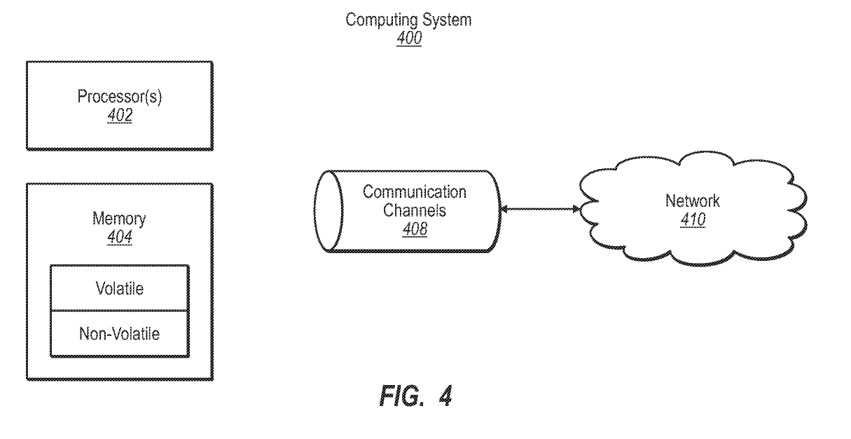

As previously mentioned, a portion of the acts described above may be performed by a computing system. For instance, the monitoring of the power usage, and the determination of an energy credit may be performed by a computing system. Furthermore, the reporting acts performed over a network may be accomplished with the assistance of a computing system. FIG. 4 illustrates a computing system 400 that could be used to perform such acts.

Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 4, in its most basic configuration, a computing system 400 typically includes at least one processing unit 402 and memory 404. The memory 404 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 404 of the computing system 400.

Computing system 400 may also contain communication channels 408 that allow the computing system 400 to communicate with other message processors over, for example, network 410. Communication channels 408 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

Reactance Compensation

FIG. 5 abstractly illustrates a real estate property 500. The real estate property 500 may be any real estate that has an associated electrical power system 510 that supplies electrical power to one or more electrical power consuming entities such as devices and/or systems (collectively referred to hereinafter as “powered devices”) on the real estate property 500. As an example, the real estate property 500 might be a residential property such as an apartment complex, a single apartment, a single family detached dwelling, a duplex, or any other residential property. The real estate property 500 might also be a commercial property such as a factory or business offices.

The real estate property 500 includes an electrical power system 510 that has a net reactivity 520. The net reactivity may differ depending on which point of the electrical power system 510 is being measured and depending on the nature and distribution of the powered devices within the electrical power system 510. The net reactivity 520 can also change with time as powered devices are turned on or off, or otherwise adjust their operational status such that power consumption changes. The electrical power system 510 also has a reactance module 530 that helps to compensate for net reactivity 520.

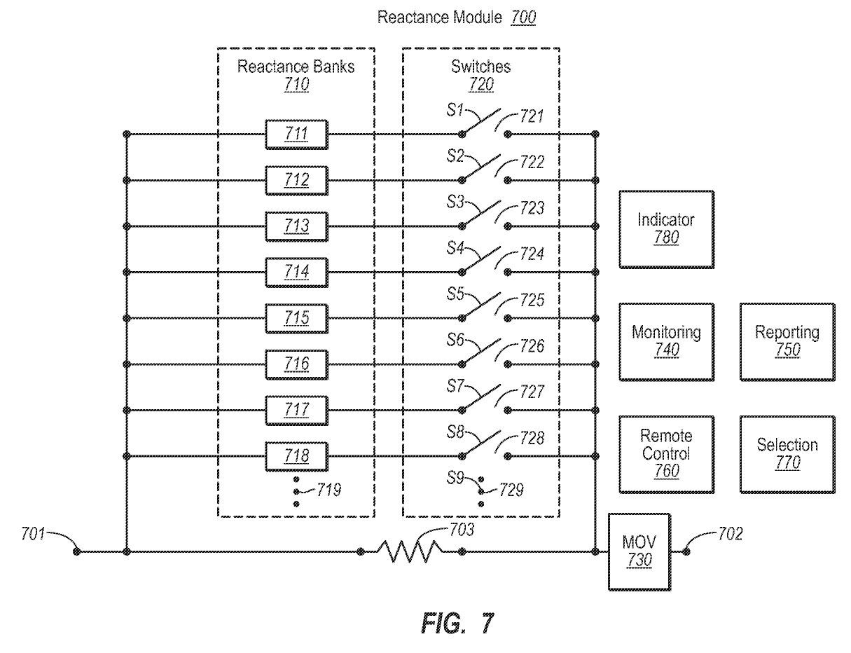

Reactivity will be described in further detail with respect to FIGS. 6A and 6B. Then, an example of a reactance module 530 and its operation will be described in further detail with respect to FIGS. 7, 8, 9 and 10. Reactance is generally defined an electrical system's opposition to alternating current. More specifically, reactance is the imaginary portion of the electrical system's impedance. Reactance is often denoted with the symbol X, whereas impedance is denoted with the symbol \tilde{Z}. The real portion of the impedance \tilde{Z} is called resistance and is often denoted with the symbol R. Impedance, resistance, and reactance are all commonly measured in ohms (Ω). The relation of impedance, resistance, and reactance are defined by the following Equation 1A:

\tilde{Z}=R+jX (1A)

where:

\tilde{Z} is total impedance;

R is the resistance (the real portion of impedance);

X is the reactance (the imaginary portion of impedance); and

j is the imaginary unit construct.

Also, since apparent power \tilde{S} is proportional to the total impedance \tilde{Z}, since real power P is proportional to the resistance R, and since reactive power Q is proportional to the reactance X Equation 1A is equivalent to Equation 1B as follows:

\tilde{S}=P+jQ (1B)

Equation 2A defines the magnitude Z or |\tilde{Z}| of the impedance in terms of resistance R and reactance X.

Z=|\tilde{Z}|=\sqrt{R²+X²} (2A)

Equation 2B is equivalent to Equation 2A except that the magnitude of apparent power S or |\tilde{S}| is defined in terms of real power P and reactive power Q as follows:

S=|\tilde{S}|=\sqrt{P²+Q²} (2B)

Equation 3A defines the phase θ₁ of the impedance in terms of resistance R and reactance X.

$${θ}_{I} = arc tan ( \frac{X}{R} ) \qquad ( 3 A )$$

If the reactance X is greater than zero, the system is said to have a net inductance and the phase θ₁ is positive. If the reactance X is equal to zero, the system is said to be purely resistive and the phase θ₁ is zero. If the reactance X is less than zero, the system is said to have a net capacitance and the phase θ₁ is negative. Equation 3B defines the phase θ_{S} of the apparent power S in terms of real power P and reactive power Q.

$${θ}_{S} = arc tan ( \frac{Q}{P} ) \qquad ( 3 B )$$

The phase θ₁ of the impedance will generally be equal to the phase θ_{S} of the apparent power. The power factor F of an electrical system at any given time is defined as the ratio of real power P to apparent power S as defined by the following Equation 4:

$$F = \frac{P}{S} \qquad ( 4 )$$

FIG. 6A illustrates an example power factor vector diagram of an electrical system having a net inductance. In other words, the reactance X, the reactive power Q and the phases 0₁ and 0_{S} are positive. FIG. 6B illustrates an example power factor vector diagram of an electrical system having a net capacitance. In other words, the reactance X, the reactive power Q and the phases 0₁ and 0_{S} are negative. In FIGS. 6A and 6B, the vector summation of the real power P vector and the reactive power Q constitute the apparent power S. The vector diagrams resistance, reactance, and impedance would appear similar.

Certain powered devices can introduce an inductance into the system. Examples of such include motors. Other powered devices can introduce capacitance into the system. Accordingly, at any given time, and at any given node in an electrical power system, if the inductive load as experience at that given node exceeds the capacitive load (if any) as experienced at that given node, that given node experiences a net inductance equal to the difference between the inductive and capacitive loads. On the other hand, if the capacitive load as experience at that given node exceeds the inductive load (if any) as experienced at that given node, that given node experiences a net capacitance equal to the difference between the capacitive and inductive loads. In those cases where there is no capacitive and inductive load experienced at a load, or in cases in which the capacitive and inductive loads completely offset each other, there is no reactance at all experienced at that node. Thus, depending on the loads that are present and active, and depending on what nodes in the circuit is being evaluated, different reactance levels may be experienced.

FIG. 7 schematically illustrates a reactance module 700 that represents an example of the reactance module 530 of FIG. 5. As previously mentioned with respect to the reactance module 530, the purpose of the reactance module 700 is to at least partially compensate for reactance in the electrical power system at the node that the reactance module 700 is connected to. In one embodiment, the reactance module 700 is pluggable into another module that is connected to the electrical power system of the real estate property. That other module might have plugged therein other types of modules such as, for example, a home automation module, a surge protector, a power monitor, or any module that might be developed in the future that has the physical interfaces needed to plug into the module.

The reactance module 700 includes a number of reactance banks 711 through 718. Although eight reactance banks 711 through 718 are shown (represented collectively as “reactance banks 710”), there may be other numbers of reactance banks as symbolized by the ellipses 719. For instance, in one embodiment, there are four banks, but there may be even as few as one, or any number between one and eight. There may also be more than eight total reactance banks.

In one embodiment, the reactance banks 710 are all capacitive banks. In that embodiment, only net inductance can be compensated for using the reactance module 700. In another embodiment, the reactance banks 710 are inductive banks. In that embodiment, only net capacitance can be compensated for using the reactance module 700. In yet another embodiment, there is a mix of capacitive banks and inductive banks. This would allow for compensation of both net inductance and net capacitance in the system.

The reactive banks may be equally sized. In other embodiments, the reactive banks might be sized in geometric proportion to achieve refined adjustment granularity. For instance, in a set of binary geometrically proportioned capacitive banks, the largest capacitor bank may have a total capacitance of 16×C (where “C” is some arbitrary amount of capacitance). There may be another capacitor bank that has a total capacitance of 8×C, another with a total capacitance of 4×C, another capacitor bank with a capacitance of 2×C, and a last capacitor bank of 1×C. This binary proportion geometry of capacitor banks could thus adjust to any capacitance between 0 (with all capacitor banks switched off), and 31×C (with all capacitor banks switched on), and may have any capacitance in-between all down to a resolution of 1×C. An additional advantage of the binary proportioning is that the banks might be configured with a binary number that is proportional to the amount of capacitance to be introduced, with each bit apportioned to control a distinct one of the capacitor banks.

In an example ternary system, there might be two capacitor banks having capacitance 27×C, two others with capacitance 9×C, two others with capacitance 3×C, and two others with capacitance 1×C. This would enable any capacitance between 0 and 80×C in increments of 1C.

The reactance banks 710 may be pluggable. For instance, suppose there are initially eight reactance banks, four being capacitive, and four being inductive. Now suppose that usage history of the electrical power at the real estate property suggests that only two of the inductive banks are really needed even when the capacitive loads at the real estate property dominate, and that often four capacitive banks are insufficient to fully compensate for net inductance with the inductive loads dominate. In that case, two of the inductive banks may be unplugged, and replaced by two capacitive banks. The reactance banks might each have some identifier that identifies to the reactance module 700 what type of reactance bank they are (i.e., capacitive or inductive), and what kind of strength they have (e.g., 8×C versus 2×C). The reactance module 700 might include some solid-state logic or perhaps some other processing capability that controls which reactance banks are turned on and off considering the reactance banks' type and strength.

Referring back to FIG. 7, the reactance module 700 is connected to the electrical power system 510 of the real estate property 500. The precise configuration of this connection is not critical except to say that the connection should be such that the reactance banks 710 are reactively coupled into the electrical power system such that when they are selected, they introduce reactance into the electrical power system 510. FIG. 7 illustrates just one of various ways in which such a connection may be made. In the particular example of FIG. 7, the reactance banks 710 are coupled in parallel with each other and with a resistor 703 between connection nodes 701 and 702. The connection nodes 701 and 702 might be in series in one power supply line or the other.

In FIG. 7, all of the reactance banks are independently and reversibly selectable such that, when selected, the corresponding reactance bank is reactively coupled to the connection nodes, and such that, when not selected, the corresponding reactance bank is not reactively coupled to the connection nodes. This is accomplished via a switch for each reactance banks. For instance, switches 720, which includes switches 721 through 728 corresponding to reactance banks 711 through 718, respectively. The ellipses 729 represents that the number of switches may be more or less than 8. For instance, if there were 10 total reactance banks, there may be ten switches, one for each reactance bank. In some cases, one or more of the reactance banks may not have a switch at all, but instead might be permanently coupled to the connection nodes 701 and 702. In FIG. 7, the switches 721 through 729 are control via signals S1 through S9, respectively.

By properly adjusting which of the reactance banks are switched on, and which are switched off, the power factor of the electrical power system may be improved. For instance, if there is a lot of net inductance in the electrical power system 510, most or all of the capacitance banks may be turned on, and if there are any inductance banks, the inductive banks are turned off If there is only a little net inductance in the electrical power system, perhaps only a few of the smaller capacitance banks are turned on, and if there are any inductive banks, the inductive banks are turned off. If there is only a little net capacitance in the electrical power system, perhaps only a few of the smaller inductance banks are turned on, and if there are any capacitive banks, the capacitive banks are turned off. Finally, if there is a lot of net capacitance in the electrical power system, most or all of the inductive banks may be turned on, and if there are any capacitive banks banks, the capacitive banks are be turned off.

As additional advantages, the use of the inductive banks and the capacitive banks will tend to smooth out spikes and other irregularities in the power supply, thereby conditioning the power for further consumption. The use of reactive banks would further lower end rush current and allow equipment to run cooler. A metal-oxide varistor (MOV) 730 is coupled within the current path to provide further protection against current spikes.

The reactance module 700 also includes a monitoring module 740 configured to detect a power efficiency of an electrical power system coupled to the connection nodes 701 and 702 when the electrical power system is coupled to the connection nodes. In one embodiment, the monitoring module 740 detects the power factor of the electrical power system 510. Mechanism for detecting power efficiency and power factor are known in the art, and thus will not be described here in detail. The monitoring module 740 may perhaps log the sampled power efficiencies or power factor, and perhaps store the log to non-volatile memory. The memory may be later read using a diagnostics device that might be selectively plugged into the reactance module 700.

The monitoring module 740 might also detect power factor using current and/or voltage signature analysis. Typically power factor can be measured by 1) measuring instantaneous voltage and current levels; 2) measuring voltage and phase between voltage and current, or 3) measuring current and phase between voltage and current. However, current or voltage signature analysis is a different way to measure power factor, and provides additional useful information.

As each appliance or other electrical consumption device turns on or off, or otherwise changes from one operational mode to another, the appliance will change electrical power requirements. This has the effect of changing dynamically the amount of current that is drawn from the electrical power system and/or changing (even if slightly) the voltage of the electrical power system. In fact, this change is more than a mere binary function, but is interpretable as a dynamic signal. The characteristics of the dynamic signal applied back into the electrical power system tends to be the same each time the electrical consumption device transitions from a predetermined prior operational mode to a predetermined subsequent operation mode. Thus, the mode transition of the electrical consumption device may be thought of as having a certain signature on the electrical power system.

The signature of a particular electrical consumption device may be common amongst all devices of that same type. In those cases, the signature may be fixed as part of the knowledge of the monitoring module 740. In other cases, some user interaction might assist in identifying a particular signature corresponding to a device. For instance, the home owner might be prompted to select a device, and turn the device on. The home owner might identify the device that was turned on to the monitoring module 740.

Sometimes the signature might be more discernable by monitoring the voltage of the electrical power system, sometimes that signature might be more discernable by monitoring the current of the electrical power system, and sometimes the signature on the voltage and the signature on the current may both be used to identify the overall signature identifying which device transitioned, and what the transition was. Such operational modes may be quite simple such as a two operation mode device that has simply an “On” operational mode and an “Off” operational mode, and may be as complex as an electrical consumption device that has dozens or even hundreds of operational modes.

Accordingly, by monitoring the current consumption characteristics of the electrical power system and/or by monitoring the voltage of the electrical power system, the monitoring module 740 might often be able to detect which electrical consumption device just transitioned from one state to another, and which states they were. For instance, the monitoring module 740 might detect that the refrigerator is no longer drawing power from the electrical power system, and therefore is not operating property. The monitoring module 740 might also detect when the refrigerator door has opened, and when the refrigerator door closes. Thus, the monitoring module 740 might use a processor to determine that the refrigerator door has been left open beyond a predetermined amount of time.

The monitoring module 740 might also detect when the television is turned on or off, when a ceiling fan is turned on or off and its current speed setting, when a basement sump pump turned on, when the security system is active and inactive, when the steam generator for a steam shower is on, and so forth for any electrical consumption device that applies a unique signature to the electrical power system when the electrical consumption device transitions from one operational mode to the next operational mode. The unique signature might also be a signal that is dispatched onto the electrical power system by the electrical consumption device that follows some protocol for communication over an electrical power system. Thus, one, some, or all of the electrical consumption devices could have processing logic that sets out to signal over the electrical power system various information regarding its identity, and operational characteristics. Such information might also be used by monitoring the current or the voltage of the electrical power system. That said, the signature may just be an inadvertent application of a dynamic signal on the electrical power system that happens during the normal course of switching from one mode to another, and without any particular communication mechanism for communicating over the electrical power system.

The detection of which devices have transitioned from one mode to another can be very valuable information. For instance, the power factor contribution of the transition may be known and thus the overall power factor may be calculated based on which devices are on, and in which operation mode and which devices are off. For instance, if an air conditioning unit turns on, and the air conditioner units are known to be a highly inductive load, an additional capacitor bank may be turned on to compensate.

However, the information of which devices are turned and off may be used for any number of reasons. For instance, this information may be used to detect which devices are failing or aging. For example, when the monitoring module 740 detects that an air conditioning unit turns on, it can also detect the power usage of that air conditioning unit. Over time, the air conditioning unit will become less efficient. The monitoring module 740 can monitor this efficiency and even report lessened efficiency to remote locations. The owner or occupant of the real estate property may take corrective action, such as repairing or replacing the air conditioning unit. The information may perhaps be provided to third parties that might assist in correcting the problem. For instance, if the air conditioning unit is under warranty, the information might be communicated to the air conditioner installer or supplier.

The monitoring module 740 may be used to apply intelligence and draw conclusions. For instance, the monitoring module 740 may monitor power to determine whether there is someone home. For instance, if for a predetermined period of time there is no indication that a refrigerator door was opened or closed, or that any light switch has been turned on or off, then the system might conclude that no one is home, and perhaps take appropriate action such as arming the security system, turning some lights off, turning the television off, closing the garage doors, or the like. Of course, case should be taken that such automation not extend beyond useful limits. For instance, the monitoring module 740 might have to conclude beyond a certain probability that no one is home before taking some actions, and should perhaps refrain from taking action that it is not certain that an owner would want to be taken. For instance, if the system concludes that no one is home, it might still refrain from closing a garage door. After all, a car might have been left in the path of the garage door, and closing the garage door might cause damage to the vehicle. Alternatively, there might be safety implications associated with closing a garage door automatically without a contemporaneous user command. Instead, the system might take less intrusive action and perhaps send the owner a text message reminding that the garage door is open, and suggesting the door be closed and providing a control for the user to close the door.

The reactance module 700 might also consider seasonal effects. For example, if it is winter, and a temperature sensor indicates that outdoor temperature is below some threshold, the system might be less likely to interpret a voltage or current signature as corresponding to the turning on of an air conditioner. If it is nighttime, then the system might be less likely to conclude that there is no one home since inactivity is normal in the nighttime. If it is during a time of year that electrical costs are cheaper, the system might be less inclined to make suggestions as to how to improve electrical efficiency, and perhaps how often the reactance modules should be switched out. If it is during a time of year when electrical costs are more expensive, on the other hand, the reactance module may adjust reactance banks more frequently, and be somewhat more active in alerting the owner of opportunities to reduce electrical consumption.

In one embodiment, a reporting module 750 is configured to report over a communication network regarding a power status (e.g., the power efficiency or power factor) of the electrical power system 510 based on power efficiency monitored by the monitoring module 740. Perhaps the reporting module 750 might also report the amount of the net inductance or the net capacitance, or at least might convey sufficient information that the net inductance or net capacitance might be estimated or derived. The reporting module 750 might also report regarding individual performance of one or more electrical consumption devices as previously mentioned.

Optionally, a remote control reception module 760 receive commands over a communication network, which may be the same as, or different than, the communication network that the reporting module 750 communicates over. The communication network might be, for example, the Internet, or another Wide Area Network (WAN) or Local Area Network (LAN). If capable of communicating over the Internet, the reporting module 750 and the remote control reception module 760 may include and perhaps even share a Transmission Control Protocol (TCP)/Internet Protocol (IP) (i.e., “TCP over IP” or “TCP/IP”) based protocol stack. Such a stack may be implemented in hardware, software, firmware, or a combination thereof. The remote control reception module 760 may respond to a set of commands issued by a remote entity, such as perhaps a power monitoring service. Some of those commands might be to adjust the net inductance or net capacitance correction offered by the reactance module 700.

The remote control reception module 760 responds to such commands by causing the selection module 770 to turn reactance bank(s) on and/or turn reactance banks off Alternatively, or in addition, the selection module 770 may respond to manual instructions to turn on and/or off reactance modules. For instance, the selection module 770 might be coupled to a manual switch, or perhaps might be communicatively coupled to a communication port through which a pluggable diagnostics device may be plugged in.

Accordingly, the reactance module 700 may be adjusted locally or remotely, and with user input, or perhaps even automatically such that bank selection occurs without contemporaneous intervention by a user.

The reactance module 700 may also include a visual indicator 780 such as, for example, a Light Emitting Diode (LED) or a set of LEDs. Such LEDs might indicate 1) a number of reactance banks that are active, 2) a reactance contribution of the selected reactance banks, 3) a polarity of the reactance contribution (e.g., whether the reactance contribution is inductive or capacitive), 4) other operational status information.

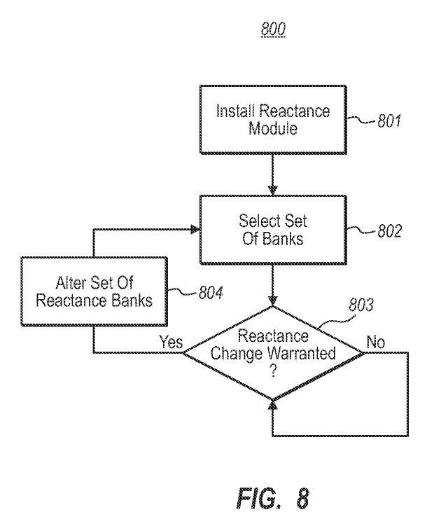

FIG. 8 illustrates a flowchart of a method 800 for improving the electrical power efficiency of a real estate property. First, an adjustable reactance module (such as the reactance module 700 of FIG. 7) is installed into an electrical power system of the real estate property (act 801). As previously mentioned, the electrical power system has a net reactance power that is degrading a power factor of the electrical power system. Initially, an initial set of the reactance banks are selected (act 802) such that the selected initial set of reactance banks are reactively coupled to the electrical power system. The initial set is selected to thereby reduce or eliminate the net reactance of the electrical power system and improve the power factor of the electrical power system.

As previously mentioned, the reactance module may be a capacitive module in which case the reactance banks are each capacitive banks. In that case, the net inductance of the electrical power system may be at least partially compensated for using the reactance module. If the reactance module is, on the other hand, an inductive module, the reactive banks would be inductive banks. In that case, the net capacitance of the electrical power system may be at least partially compensated for using the reactance module. In another embodiment, the reactance module may be mixed, and include one or more capacitive banks, and one or more inductive banks.

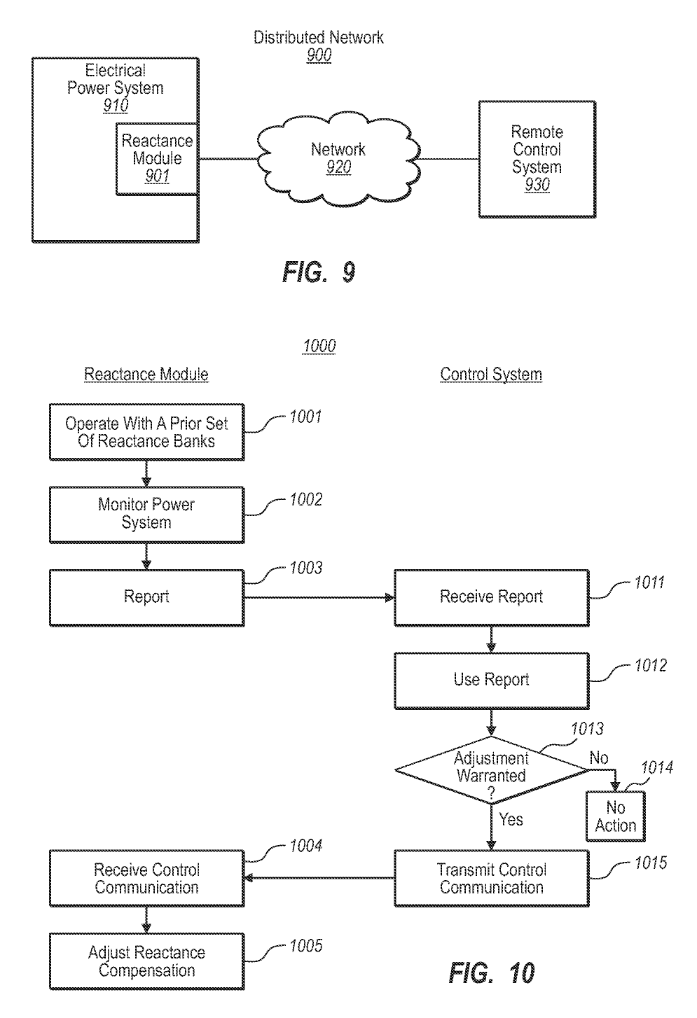

After the previous set of reactance banks are selected (act 802), there is a determination on whether or not the net reactance has changed since the last time there was a selection of a set of reactance banks, that would be sufficient to warrant a change in the set of selected reactance banks (decision block 803). As part of this decision, the reactance module monitors an efficiency of the electrical power system, and perhaps logs at least one sampling of the monitored efficiency. This decision might be made remotely as in the case of FIGS. 9 and 10, as will be described in further detail below.

The method 800 remains in the decision state (decision block 803), until it has determined that the set of selected reactance banks should be changed (Yes in decision block 803). In response, the selection module of the reactance module alters the set of selected reactance banks (act 804) so as to be reactively coupled to the electrical power system.

FIG. 9 illustrates a distributed network 900 that includes a reactance module 901 installed in an electrical power system 910. For instance, the reactance module 901 may be the reactance module 700 of FIG. 7, and the reactance module 530 of FIG. 5. The distributed network 900 also includes a communication network 920 and a control system 930, such as a power monitoring service. FIG. 10 illustrates a flowchart of a method 1000 for a reactance module to improve electrical power efficiency of an electrical system of a real estate property in conjunction with a remote control system 930. The method 1000 of FIG. 10 will now be described with frequent reference to the distributed network 900 of FIG. 9. Some of the acts of the method 1000 are performed by the reactance module 901 as represented in the left column of FIG. 10 under the heading “Reactance Module”. Others of the acts are performed by the remote control system 930 as represented in the right column of FIG. 10 under the heading “Control System”.

The reactance module first operates such that an initial subset of the reactance banks are selected so as to be enabled and reactively coupled to the electrical power system (act 1001). The reactance module monitors the power efficiency of the electrical system while the reactance module is operating with that selected subset of the reactance banks being enabled (act 1002). The reactance module reports over the communication network regarding the monitored power efficiency (act 1003).

The remote control system 930 receives the report from the reactance module over a communication network 920 (act 1011). The remote control system then uses that power efficiency information (act 1012). For instance, the remote control system might determine an energy credit earned by the real estate property given historical power usage. In one embodiment, the calculated energy credit might be severed from the real property, and placed on the energy market. An example of how this might be done is described in the text the follows the heading “Energy Credit Harvesting below. In addition, the remote control system might evaluate the report (act 1012), and determine whether the reactance module should be adjusted (decision block 1013). If the reactance module need not be adjusted (No in decision block 1013), the report is handled without further action (act 1014). On the other hand, if the reactance module would improve if the reactance module were to change the number of reactance banks of the reactance module that are enabled (Yes in decision block 1013), the remote control system transmits control communication to reactance module (act 1015). This control communication is structured to cause the reactance module to change the number of reactance banks that are enabled.

The reactance module then receives the control communication over a communication network (act 1004) and alters the set of selected reactance banks that are enabled (act 1005).

Accordingly, the structure and operation of a reactance module, and the layout and operation of a distributed network have been described that enable the inductive or capacitive correction offered by a reactance module to be dynamically adjusted. By allowing such dynamic adjustment, the power factor can be corrected in a timely basis in response to dynamically changing conditions as different loads are turned on and off, and as loads adjust their inductive or capacitive contribution into the system.

A single reactance module might be used for an entire system, or perhaps there might be multiple such reactance modules distributed throughout the system. For instance, if there are multiple subsystems in an electrical power system, there might be one reactance module for each electrical subsystem.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating an energy credit by transforming a real estate property, and severing the energy credit from the real estate property, the method comprising:
an act of monitoring a power usage of a real estate property before a transformation of the real estate property is made;
an act of an entity other than an owner of the real estate property at least facilitating the transformation of the real estate property, the transformation improving an energy efficiency of the property;
an act of monitoring a power usage of the real estate property after making the transformation;
an act determining an energy credit that results from the transformation based on the act of monitoring; and
an act of the entity receiving at least a portion of the energy credit resulting from the transformation of the real estate property made by the entity.

2. The method in accordance with claim 1, further comprising an act of gathering data regarding the monitored power usage.

3. The method in accordance with claim 1, further comprising an act of reporting at least a portion of the gathered data to a third party other than the entity and other than the owner of the real estate property.

4. The method in accordance with claim 3, further comprising:
an act of the third party using the at least a portion of the gathered data to present an offer to the owner of the real estate property.

5. The method in accordance with claim 1, wherein the transformation comprises installing one or more windows on the real estate property.

6. The method in accordance with claim 1, wherein the transformation comprises installing one or more furnaces on the real estate property.

7. The method in accordance with claim 1, wherein the transformation comprises installing a fireplace on the real estate property.

8. The method in accordance with claim 1, wherein the transformation comprises installing a roof on the real estate property.

9. The method in accordance with claim 1, wherein the transformation comprising installing solar panels on the real estate property.

10. The method in accordance with claim 1, wherein the act of monitoring a power usage of a real estate property comprises:
an act of a power monitoring device installed into an electrical power system of the real estate property monitoring one or more parameters of the electrical power system over a period of time.

11. The method in accordance with claim 10, wherein the act of monitoring a power usage of a real estate property further comprises:
an act of the power monitoring device reporting over a network information regarding at least one sample of the one or more parameters taken over the period of time.

12. The method in accordance with claim 11, wherein the act of determining an energy credit that results from the transformation is performed using at least in part a remote entity that uses the information reported by the power monitoring device.

13. The method in accordance with claim 12, wherein the remote entity uses a computing system to perform the act of determining the energy credit.

14. A method for transforming a real estate property and receiving payment for the transformation, the method comprising:
an act of an entity other than an owner of the real estate property at least facilitating transformation of the real estate property, the transformation improving an energy efficiency of the property and resulting in an energy credit being issued to the owner of the real estate property; and
an act of the entity receiving at least partial ownership in the energy credit that resulted from the transformation of the real estate property as partial consideration for the facilitation of the transformation of the real estate property.

15. A method in accordance with claim 14, wherein the facilitation of the real estate property comprises selling a product to the owner of the real estate property, wherein when the owner of the real estate properly uses the product on the real estate property, the energy efficiency of the property is improved.

16. The method in accordance with claim 14, further comprising:
an act of the entity providing additional consideration to the owner in consideration for the at least partial ownership in the energy credit.

17. The method in accordance with claim 16, wherein the additional consideration comprises coupons.

18. The method in accordance with claim 16, wherein the additional consideration comprises money.

19. The method in accordance with claim 16, wherein the additional consideration comprises donations.

20. A method for transforming a real estate property and receiving payment for the transformation, the method comprising:
an act of an entity other than an owner of the real estate property at least facilitating transformation of a real estate property, the transformation improving an energy efficiency of the property and resulting in an energy credit being issued to the owner of the real estate property;
an act of the entity receiving at least partial ownership in the energy credit that resulted from the transformation of the real estate property as partial consideration for the transformation of the real estate property;
an act of at least one of the following occurring as further consideration for the transformation of the real estate property:
an act of the entity receiving transfer fee rights in the real estate property; and
an act of the owner entering into an obligation secured by the real estate property to pay the entity.

21. The method in accordance with claim 20, wherein the method includes the act of the entity receiving transfer fee rights in the real estate property, but not the act of the owner entering into an obligation secured by the real estate property to pay the entity.

22. The method in accordance with claim 20, wherein the method includes the act of the owner entering into an obligation secured by the real estate property to pay the entity, but not the act of the entity receiving transfer fee rights in the real estate property.

23. The method in accordance with claim 20, wherein the method includes both the act of the owner entering an obligation secured by the real estate property to pay the entity, as well as the act the entity receiving transfer fee rights in the real estate property.

24. The method in accordance with claim 20, wherein the method does include at least the act of the entity receiving transfer fee rights in the real estate property, wherein the entity receives a transfer fee at a subsequent sale of the real estate property to another owner, the method further comprising:
an act of the owner negotiating with a real estate broker involved or to be involved in the subsequent sale for the real estate broker to pay all or a portion of the transfer fee at the subsequent sale.

25. The method in accordance with claim 20, wherein the method does include at least the act of the entity receiving transfer fee rights in the real estate property, wherein the entity receives a transfer fee at a subsequent sale of the real estate property to another owner, the method further comprising:
an act of the owner negotiating with a real estate broker involved or to be involved in the subsequent sale for the real estate broker to pay all of the transfer fee at the subsequent sale.

26. The method in accordance with claim 20, wherein the method does include at least the act of the entity receiving transfer fee rights in the real estate property, wherein the entity receives a transfer fee at a subsequent sale of the real estate property to another owner, the method further comprising:
an act of the owner negotiating with a real estate broker involved or to be involved in the subsequent sale for the real estate broker to pay only a portion of the transfer fee at the subsequent sale.

27. The method in accordance with claim 20, wherein the transformation comprises installing one or more air conditioning units on the real estate property.

28. The method in accordance with claim 20, wherein the transformation comprises installing one or more programmable light switches on the real estate property.

29. The method in accordance with claim 20, wherein the transformation comprises installing one or more thermostats on the real estate property.

30. The method in accordance with claim 20, wherein the transformation comprises installing one or more energy generators on the real estate property.

31. The method in accordance with claim 30, wherein at least one of the one or more energy generators comprises a solar cell panel.

32. The method in accordance with claim 30, wherein at least one of the one or more energy generators comprises a wind turbine.

33. The method in accordance with claim 30, wherein at least one of the one or more energy generators comprises a ground heat pump.

34. The method in accordance with claim 30, wherein the transformation comprises installing a home automation system.
